(19) United States
(12) Patent Application Publication
(10) Pub. No.: US 2004/0059543 A1
(43) Pub. Date: Mar. 25, 2004

(54) Method and system for supporting therapy planning in rehabilitation

(76) Inventors: Klaus Abraham-Fuchs, Erlangen (DE); Niels Richter, Thurnau (DE); Uwe Eisermann, Kufstein (AT); Robert Setz, Rednitzhembach (DE)

Correspondence Address: HARNESS, DICKEY & PIERCE, P.L.C., P.O. Box 8910, Reston, VA, 20195, US

(21) Appl. No.: 10/612,020

(22) Filed: Jul. 3, 2003

(30) Foreign Application Priority Data
Jul. 3, 2002 (EP) 02014701.3

(51) Int. Cl. G06F 11/30

(52) U.S. Cl. 702/182

(57) ABSTRACT

Patient data for a patient are recorded which include measured values for measured variables relating to implementation and/or for quantification of interim results for a training program completed by the patient. In addition, a first database is provided which contains rules for linking patient data to proposals for modifying training programs. A first or a second data processing station automatically generates one or more proposals for modifying or retaining the training program completed by the patient by reverting to the first database, and outputs it/them to the first or to a further data processing station. The present method and the associated system reduce the workload and time taken for a treating physician or therapist when modifying a training program during rehabilitation.

The present application hereby claims priority under 35 U.S.C. §119 on European patent application number EP 02014701.3 filed Jul. 3, 2002, the entire contents of which are hereby incorporated herein by reference.

### FIELD OF THE INVENTION

The present invention generally relates to a method and a system for supporting therapy planning in the rehabilitation of a patient, in which the patient's training program is monitored and is modified on the basis of implementation of and/or interim results for the training.

### BACKGROUND OF THE INVENTION

A fundamental component of rehabilitation is self-training of the patient in order to improve capabilities relating to rehabilitation. Depending on the patient's respective capability deficiency, this training involves training of motor capabilities, such as strength, mobility or balance, and/or cognitive capabilities, such as attention or memory. Hence, in orthopedic rehabilitation, for example following bone fractures, and in cardiological rehabilitation, for example following a heart attack, motor capabilities are trained as a priority. In neurological rehabilitation, for example following a cerebral infarction/brain hemorrhage, on the other hand, cognitive capabilities are trained as a priority. If motor and cognitive functions in the patient are impaired, combined training of motor and cognitive capabilities is indicated. This form of training is favored, inter alia, in geriatric rehabilitation, for example for Alzheimer's disease, and also in neurological rehabilitation for complex ailments, such as stroke with hemiphelegia.

During a training program, which can extend over a period of between several weeks and a number of years, the patient needs to be continuously monitored, and, if the patient's development differs significantly from the training goal or from corresponding subsidiary training goals, the training may need to be modified. Such modification of the training program can also become necessary if, during the training, the patient develops illnesses which make it impossible for the patient to continue to perform particular exercises in the training program.

During the training program, the physician or therapist therefore normally receives appropriate feedback, particularly in the form of measured variables which reflect the patient's current performance when performing individual exercises in the training program or which reflect the result of corresponding interim tests. Other sources of information are, by way of example, entries in a patient's diary or a direct discussion with the patient. The physician or therapist then assesses the patient data, including the transmitted measured variables, intellectually in order to derive therefrom advantageous or necessary modifications to the prescribed training program. This practice is time-consuming and work-intensive, however.

The previously unpublished DE 10147471.7 discloses a method and a system for supporting the physician or therapist in the creation of a therapy plan, in which patient data from an electronic patient record are supplied to a computer-based expert system which checks the created therapy plan for contraindications, for example, on the basis of these patient data. This allows errors to be avoided when creating the therapy plan. The amount of time and work involved for modifying the training plan during therapy is not reduced by this method or system, however.

WO 01/26548 A1 describes a method and a system for telemedical treatment of orthopedic injuries, in which, during implementation of the rehabilitative training program, measured data are recorded which permit inference of the implementation of the training program or an interim result during implementation of this training program. The measured data are recorded by a handheld computer at the patient's location and are transmitted to a central data processing station in which, by reverting to a database, the measured data transmitted can be taken as a basis for automatically proposing a modification to the training program. In this case, the database contains “historical” training programs for comparable patients. The printed document also discloses comparison of the patient's training progress data with the known progress of comparative patients.

The subsequently published WO 02/062211 A2 relates to a method and a system for creating or adjusting a training program for cardiac patients. The method involves measured data for the heart being recorded while a training program is implemented for the patient and being used by the data processing station, together with data relating to this patient's medical history, which also include data about other illnesses, for automatically creating a new training program. This automated creation involves the use of rules which link the patient data to proposals for adjusting the training program or for creating a new training program.

WO 94/10634 relates to a method for automating a patient's rehabilitation using an aerobic training program, in which the training program is automatically monitored during implementation. Provision is also made for the training program to be modified on the basis of the data obtained during monitoring, but this modification is made manually by the physiotherapist in a known manner.

U.S. Pat. No. 5,890,997 relates to a method and a system for computer-assisted creation, implementation and monitoring of fitness programs in a fitness studio. This system involves the training's interim goals prescribed for the patient being automatically adjusted on the basis of recorded training data.

WO 00/78374 A1 describes a method and a system for automated management of evidence-based medical treatments. This involves recording data for the patient which describe his current medical condition. On the basis of these data, a piece of software selects a treatment plan for the patient and indicates this to the user.

DE 100 54 960 A1 relates to a system of equipment for examining the condition and the adherence to therapy and/or for preparing the therapy for a patient under a physician's treatment using remote data processing. The system also comprises an operative unit having a program unit which is suitable for altering the examination's or therapy's plans. The printed document gives no more detailed explanations of this operative unit, however.

### SUMMARY OF THE INVENTION

An object of the present invention is to a method and system for supporting therapy planning in the rehabilitation of a patient which reduces the amount of time and work involved for the treating physician or therapist.

An object of the present invention is achieved by way of the method and the system in accordance with the independent patent claims. Advantageous refinements of the method and of the system are covered by the subclaims or can be found in the description below and in the exemplary embodiments.

The present method for supporting therapy planning in the rehabilitation of a patient involves patient data for the patient being recorded which include measured values for measured variables relating to implementation and/or for quantification of interim results for a training program completed by the patient. In this context, interim result is to be understood to mean the success of training following individual training units. The measured values in this case can naturally also be values compiled from individual measured data items using prescribed calculation instructions. In addition, a first database is provided which contains a multiplicity of rules for linking patient data to proposals for modifying training programs. A first or a second data processing station, which has access to the patient data and to the first database, reverts to the first database and to the patient data for the purpose of automatically generating one or more proposals for modifying or retaining the training program completed by the patient, and outputs it/them on the first or on a further data processing station. The measured values or measured variables included in the patient data can come, by way of example, from protocols for implementing the training, for example duration, type and number of exercises, numbers of points attained from the exercises performed etc., which, in line with one embodiment of the method, are transmitted in electronic form to the first data processing station or can be retrieved from one or more corresponding databases by said data processing station. In the same way, patient data can be retrieved from a patient's diary or from an electronic patient record. Besides the measured values for measured variables relating to implementation and/or the interim results for individual training units, the patient data naturally also comprise other information, such as the age of the patient or any current or previous illnesses. On the basis of the recorded patient data and the training program prescribed for the patient, the first or second data processing station reverts to the first database for the purpose of automatically generating, in line with the rules stored therein, one or more proposals for modifying the prescribed training program, and this or these proposal or proposals are either output directly or are transmitted to a separate data processing station belonging to the treating physician therapist and are output there. The physician therapist can then confirm one or more of these proposals so that the training program currently prescribed for the patient, which is stored in a database, can be modified automatically as appropriate. Naturally, reverting to the first database can also reveal that the currently prescribed training program does not require any modification, so that in this case the first or second data processing station merely generates advice to retain the training program.

In this context, modification of the training program can relate to alteration of a multiplicity of possible configuration parameters for the training program. Examples of such configuration parameters are the degree of difficulty of individual exercises, the order of a plurality of successive exercises, the replacement of exercise units with other exercise units, the alteration of exercise times for individual exercises or subsidiary exercises or of the total time of the training program, or the shifting of the main focus of exercise between subsidiary exercises relating to various areas of capability. This is naturally not a conclusive listing, which means that all parameters relating to the implementation of the training program can be modified.

The present method and the associated system provide the physician or therapist with a computer-assisted auxiliary tool which, on the basis of the current level of the training program or of the development of the patient during training, automatically delivers modification proposals which optimize the training and which the physician or therapist then merely needs to confirm or reject. He is thus relieved of the burden of time-consuming and work-intensive assessment of the current patient data and of his own deduction of change measures.

The present method and the associated system can be used particularly advantageously for the telemedical care of patients. In the case of telemedical care, the physician therapist who created or prescribed the training program is not personally present when the training program's exercises are performed. He therefore has to obtain the data about implementation of the training and the patient's current state of health or level of development, which he requires for individual optimization of the training program, indirectly and not through his own observation.

Preferably, a system with training, therapy-control, information and communication functions is used for this rehabilitation with telemedical care. The system includes at least one terminal for the physician or therapist, one or more patient terminals and, depending on the architecture, optionally a central or peripheral server. On the physician's or therapist's terminal, a data processing station of appropriate design, the physician or therapist creates optimum training programs for the patient on an individual basis. These are transferred telematically to the (second) data processing station, the patient terminal. This terminal provides the patient with a multimedia computer workstation for performing the prescribed training exercises. During implementation of the computer-based training, preferably at the patient's home, but also in outpatient facilities, such as self-help groups or in a rehabilitation clinic, the measured variables which provide information about the scope of implementation of the training program, for example the time, number of exercises or type of exercises, and the success of training, or about numbers of points attained in individual exercises or entries in a patient's diary, are recorded directly. Transmission of these measured values to the treating physician or therapist represents a feedback loop which can be used for continuously optimizing the training program on an individual basis.

Preferably, the measured values for the measured variables relating to implementation of the training and/or for quantification of interim results or of the success of training to date are recorded automatically, or are input manually by the patient, on the second data processing station during implementation of the training program. Depending on the implementation of the method, these measured values are transmitted via a network directly to the first data processing station and/or are stored in a database to which the first data processing station has access, or the proposals for modifying the training program are generated directly in the second data processing station and are transmitted to the first or the further data processing station via the network. In one embodiment of the method, the network is also used to transmit the prescribed or modified training program which the patient needs to implement to the second data processing station. In this way, particularly in the case of telemedical care where the second data processing station is in the patient's home environment, the physician or therapist can provide care, while saving time and work, and can optimize the training program at the same time.

With the present method, the patient data are preferably recorded not just once but rather repeatedly during the training program in order to be able to react to any altered or unexpected development of the patient in good time by modifying the training program. Preferably, at least some of the measured values for the respective recorded measured variables for the patient data are compared with threshold values which, by way of example, have been stored beforehand for the respective measured variable in a database by the treating physician or therapist. This comparison makes it possible to establish whether the success of training in individual exercise segments is better, worse or equal to the physician's or therapist's expectation. In the event of values exceeding or falling short of the threshold values, a modification proposal can then be automatically generated. Besides stipulation of the threshold values in line with the physician's or therapist's experience, these can also be calculated as average values for a comparable patient collective.

In the latter case, training progress data for a multiplicity of comparative patients, combined into a patient collective, who have already implemented a comparable training program are preferably made available. One or more comparative curves for the respective measured variables are calculated from these training progress data using calculation instructions and are stored. The patient's respective current measured values are automatically compared with measured values for the stored comparative curve which correspond to the respective time or to the respective training stage, in order to generate proposals for modifying the training program if the patient's measured values differ from the comparative curve by a prescribable minimum value. In this context, the training progress data are preferably stored in a database to which the first data processing station has access.

For a proposal for modifying the training program, it is also additionally possible to generate advice containing organizational recommendations of action which result from the modification. Such recommendations of action can include, by way of example, resource planning, such as care-service resources, transfer of the patient to other specialist departments or external physicians and therapists, or cost-center information, such as provision of an application for cost transfer or cost accounting.

In another form of the present method, it is additionally possible for prognoses of progress to be created for the further development of the patient. Thus, by way of example, it is frequently not immediately possible to predict for a patient starting therapy directly after a stroke whether the success of therapy will be sufficient for reintegration into professional life, or whether professional incapacity will persist despite the therapy. By repeatedly recording the measured variables for quantification of the interim results respectively attained within the training program, it is possible to create a progress curve for the progress of therapy and to compare it with a comparative curve from a patient collective comprising comparative patients. Such a comparison can also be made in differentiated fashion by means of comparison with two disjunct subgroups from the historical patient collective, among which one subgroup contains patients who remain professionally incapacitated while the other subgroup contains patients who were able to return to professional life again. By comparing the patient's progress in therapy with the comparative curves for the two subgroups, it is thus possible to draw an early conclusion from the individual progress of therapy, for example if the patient's comparative curve has left the area for the professionally incapable collective and also the area in which the two collectives overlap. In such a case, it is again automatically possible to send corresponding information to the treating physician or therapist, possibly complemented by advice regarding consequences, such as a proposal for modification of the training program or advice that it is necessary to introduce a professional incapacity pension etc.

Naturally, the measured variables recorded during the training program can also cover the patient's compliance, which can likewise be decisive for modification of the training program.

As a particular variant of automated generation of proposals for modifying the training program, provision can be made for a warning to be generated which indicates unfavorable configuration parameters for the training program and provides a link to patient data which are a reason for the warning.

The rules contained in the first database cover, in particular, also medically known influences of other illnesses (comorbidity, multimorbidity) which are restrictions on training programs relating to the basic illness currently being treated. Thus, by way of example, the strain on circulation as a result of physiotherapeutic training following a joint implantation needs to be chosen differently, when the patient has cardiac insufficiency, than in the case of patients with a healthy heart. The information about multimorbidities can be drawn, for example automatically, from an electronic patient record for the patient. This has the great advantage that patient illnesses which suddenly appear for the first time, and which a physician providing telemedical treatment might not even discover, are also taken into account automatically as a result of the repeatedly recording of the patient data during therapy, and result in appropriate modification of the training program.

In one development of the present method, further data about the success of therapy as an input for generating modification proposals can be obtained by virtue of test programs which measure the success of therapy being implemented at regular intervals in addition to the training units. These additional staging tests can be used to implement training and to measure success independently of one another.

In addition, the present method preferably takes into account reciprocal dependencies for the success of training in different capability categories when the patient is suffering from a plurality of capability deficiencies at the same time. In this context, the automatic generation of modification proposals can involve appropriately provided rules in the first database ensuring that balanced training success arises in all categories, and one category does not improve to the detriment of another. Capability categories which can be trained together in any combination are, by way of example, cable, or it may be remote and use modems over telephone lines. In this system, the treatment professional 18 might send a signal to the handheld computer 16 to tell patient 12 to exercise.

In the present invention, as shown in FIG. 4, the same treatment professional 18, using PC 22, may treat another patient 24 with another PORD 26 communicating with another handheld computer 28 which in turn communicates with the central computer 20. The number of patients 12 and 24 being treated may be expanded and is not limited to only two patients. The handheld computers 16 and 28 may, most preferably, include additional output capabilities selected from the group consisting of RS-232 output, USB output, parallel port output, light output, textual, graphical, audible output, Ethernet input, RF communications output, IR communications output and tactile output.

In another embodiment, as shown in FIG. 5, another treatment professional 30, using PC 32, may treat the other patient 24 while the original treatment professional 18 treats the original patient 12. Treatment of the patients 12 and 24 can also be shifted between treatment professionals 18 and 30 as schedules and responsibilities dictate. Alternatively, review, consultation, and related communication between treatment professionals 18 and 30 is possible, and may take place through central computer 20 or by telephone or in face-to-face discussions. The number of patients being treated and/or the number of treatment professionals may be expanded and is not limited to only two.

In another embodiment, shown in FIG. 6, another central computer 34 communicates with the original central computer 20 and the treatment professional 18 uses original PC 22 to communicate with the another central computer 34 rather than directly with the original central computer 20. Communication between the central computers 20 and 34 may be via modem the detailed description and specific examples, while indicating exemplary embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows an overview of the method and the system for supporting therapy planning in accordance with the present invention; and

FIG. 2 shows an overview of the networking of the first and second data processing stations, including the recording of individual measured variables.

### DETAILED DESCRIPTION OF THE EXEMPLARY EMBODIMENTS

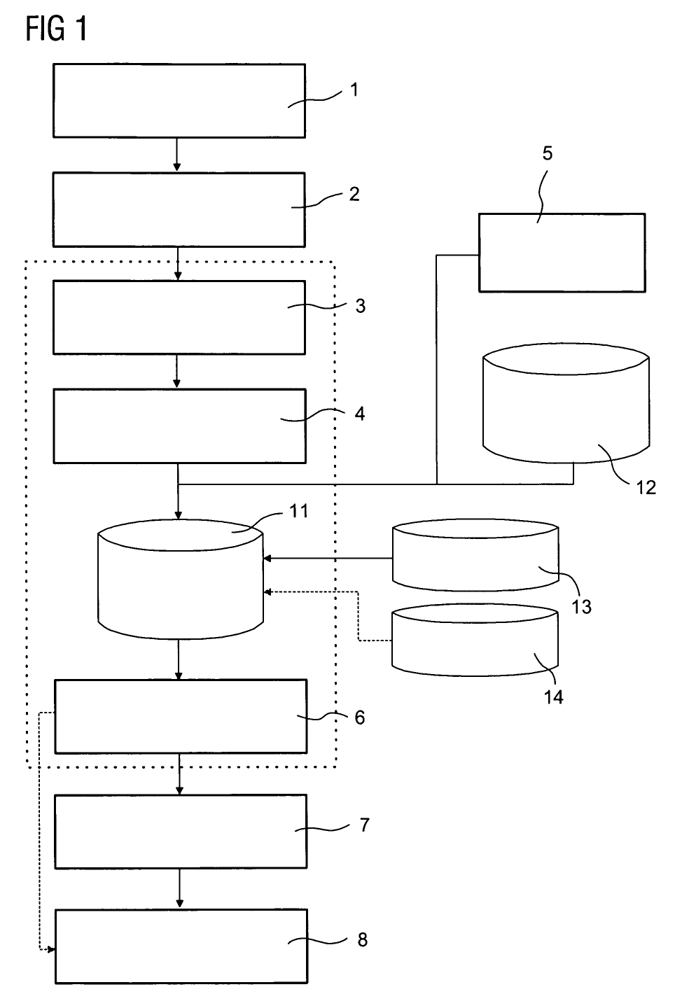

FIG. 1 shows a schematic sequence for carrying out the present method and also part of the associated system. In the first step 1, an individual training program is created for the patient, and in step 2 it is transmitted to the patient's computer workstation (second data processing station) via an appropriate network connection. During the training program, relevant measured variables for implementation of the training are repeatedly recorded (step 3) and are transmitted to the expert system, particularly the first data processing station with the corresponding processing module (step 4). In addition, data are requested from a database 12 containing the patient's electronic patient record, and also any further information is requested by questioning the patient and digitally recording the corresponding information (step 5).

Finally, by reverting to a database 11 containing expert rules for optimizing a training program, proposals for modifying the patient's prescribed training program are automatically generated (step 6). It goes without saying that corresponding modification proposals are generated only if the currently prescribed training program differs from the links contained in the database 11. Preferably, a modification proposal is created only if the patient's respective recorded measured variables exceed or fall short of corresponding threshold values which are stored in a further database 13 to which the expert system has access.

The proposals for modifying the training program are finally displayed on the first data processing station or, if the physician or therapist has been assigned another data processing station, are transmitted to this data processing station via a network and are output thereon (step 7). Finally, confirmation of one or more of the proposals for modifying the training program causes the correspondingly modified training program to be transmitted to the patient's (second) data processing station in order to replace the previously prescribed training program (step 8).

As an example of necessary modification of the training program in cardiological rehabilitation, a heart attack patient will be assumed who, following a stay in the clinic, continues his stamina training, prescribed as the training program, on a cycle ergometer at home. In this context, the patient is provided with a (second) data processing station which can intermittently interchange data with a (first) data processing station in the clinic via a network. During the training, vital parameters such as heart rate and blood pressure are measured, and following training the second data processing station is used to request from the patient aspects of his condition, such as pain and strain. The corresponding values of the vital parameters and of the condition are transmitted to the first data processing station in the clinic via the network. By way of example, the measurements show high (poor) values, whereas questioning shows low (good) values—the patient did not find training very painful or much of a strain. In this example, automatic data evaluation by the first data processing station in the clinic might generate the following proposals for modifying the training program for further treatment:

1. Modification of training: since the objective data are inauspicious in view of the current prior illness, for example arteriosclerosis of the coronary vessels, the intensity of training, for example indicated in watts, is being reduced, the training time is being increased and the density of training is being maintained. The information about the presence of arteriosclerosis comes from the electronic patient record, which is being aligned at the same time. The subjective data (patient's diary) are being used for creating the new training, but play a minor role. Alternatively, a change of form of stress and adjustment of the stress components might be proposed, for example by replacing training on the cycle ergometer with walking.

2. Modification of additional monitoring: the number of measurements taken during training and after training is being increased.

3. Information and communication: it is suggested that the therapist contact the patient. The patient is provided with comprehensive information about the alterations.

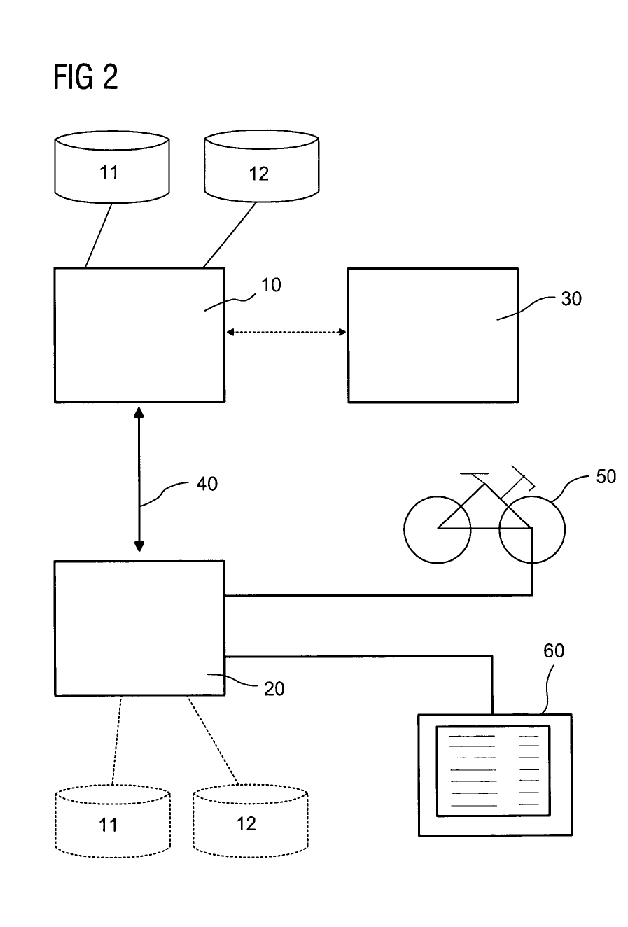

FIG. 2 shows, by way of example, the networking of the first data processing station 10 to the second data processing station 20 in the patient's domestic environment via a network 40. The first data processing station 10 can be connected to a further data processing station 30, to which the physician or therapist has access, via the same or another network 40. The first data processing station 10 has, in particular, access to a database 12 containing the electronic patient record and to a database 11 containing the expert rules. In another refinement, the second data processing station 20 can also be the expert system with access to the corresponding databases 11, 12 (indicated in dashes).

The respective current measured values for the measured variables relating to implementation and/or the interim results for the training program completed by the patient can be recorded using appropriate interfaces, for example by an ergometer 50 directly, or, in the case of questionnaires which are to be evaluated by the patient as appropriate and are shown on the computer workstation's screen 60, directly using the second data processing station 20.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for supporting therapy planning in the rehabilitation of a patient, in which:
recording patient data for a patient, the patient data including measured values for measured variables relating to implementation and/or for quantification of interim results for a training program completed by the patient;
providing a first database containing rules for linking patient data to proposals for modifying training programs;
automatically generating, by way of a first or a second data processing station, one or more proposals for modifying or retaining the training program completed by the patient by reverting to the first database and the patient data; and
outputting the generated proposals the first or on a further data processing station, wherein the rules contained in the first database take into account reciprocal dependencies for success of training in different capability categories in order to ensure balanced training success.

2. The method as claimed in claim 1, further comprising:
confirming one or more of the generated proposals by an input from a user; and
modifying at least one completed training program using at least one confirmed proposal.

3. The method as claimed in claim 1, further comprising producing an automatic warning upon identification of an unfavorable link between the patient's training program and the recorded patient data, the warning being output on the first and/or on a further data processing station together with that portion of the patient data which relates to the unfavorable link.

4. The method as claimed in claim 1, further comprising retrieving from a second database at least some of the patient data that contains an electronic patient record.

5. The method as claimed in claim 1, wherein the measured values for the measured variables relating to implementation and/or for quantification of interim results for the training program completed by the patient are recorded automatically, or are input by the patient, on the second data processing station during implementation of the training program.

6. The method as claimed in claim 1, further comprising repeatedly recording and updating the patient data during the training program in order to automatically generate proposals for modifying the training program.

7. The method as claimed in claim 1, wherein generation of a proposal for modifying the training program additionally involves generation and output of advice including organizational recommendations for action which result from the modification.

8. The method as claimed in claim 1, wherein the rules contained in the first database take into account any influences of other illnesses in the patient, which are recorded in the patient data, on the training program.

9. A method for supporting therapy planning in the rehabilitation of a patient, comprising:
recording patient data for a patient, the patient data including measured values for measured variables relating to implementation and/or for quantification of interim results for a training program completed by the patient;
providing a first database which contains rules for linking patient data to proposals for modifying training programs;
automatically generating, at a first or a second data processing station (10, 20), one or more proposals for modifying or retaining the training program completed by the patient by reverting to the first database and the patient data; and
outputting the generated proposals on the first or on a further data processing station, wherein the rules contained in the first database take into account influences of other illnesses in the patient, which are recorded in the patient data, on the training program.

10. The method as claimed in claim 9, in that one or more of the generated proposals is confirmed by an input from a user, and the patient's completed training program is modified using these confirmed proposals.

11. The method as claimed in claim 9, wherein at least some of the patient data are retrieved from a second database which contains an electronic patient record.

12. The method as claimed in claim 9, wherein the measured values for the measured variables relating to implementation and/or for quantification of interim results for the training program completed by the patient are recorded automatically, or are input by the patient, on the second data processing station during implementation of the training program.

13. The method as claimed in claim 9, wherein the patient data are repeatedly recorded and updated during the training program in order to automatically generate proposals for modifying the training program.

14. The method as claimed in claim 9, wherein generation of a proposal for modifying the training program additionally involves generation and output of advice including organizational recommendations for action which result from the modification.

15. A method for supporting therapy planning in the rehabilitation of a patient, comprising:
recording patient data for a patient, the patient data including measured values for measured variables relating to implementation and/or for quantification of interim results for a training program completed by the patient;
providing a first database that contains rules for linking patient data to proposals for modifying training programs;
automatically generating, from a first or a second data processing station, one or more proposals for modifying or retaining the training program completed by the patient by reverting to the first database and the patient data; and
outputting the generated proposals on the first or on a further data processing station, wherein generation of a proposal for modifying the training program additionally involves generation and output of advice including organizational recommendations for action which result from the modification.

16. The method as claimed in claim 15, wherein one or more of the generated proposals is confirmed by an input from a user, and the patient's completed training program is modified using these confirmed proposals.

17. The method as claimed in claim 15, wherein at least some of the patient data are retrieved from a second database which contains an electronic patient record.

18. The method as claimed in claim 15, wherein the measured values for the measured variables relating to implementation and/or for quantification of interim results for the training program completed by the patient are recorded automatically, or are input by the patient, on the second data processing station during implementation of the training program.

19. The method as claimed in claim 15, wherein the patient data are repeatedly recorded and updated during the training program in order to automatically generate proposals for modifying the training program.

20. A method for supporting therapy planning in the rehabilitation of a patient, comprising:
recording patient data for a patient, the patient data including measured values for measured variables relating to implementation and/or for quantification of interim results for a training program completed by the patient;
providing a first database containing rules for linking patient data to proposals for modifying training programs;
automatically generating, from a first or a second data processing station, one or more proposals for modifying or retaining the training program completed by the patient by reverting to the first database and the patient data; and
outputting the generated proposals on the first or on a further data processing station (30), wherein training progress data for a multiplicity of comparative patients, combined into a patient collective, who have already implemented a comparable training program are made available,
one or more comparative curves for the measured variables are calculated from the patient collective's training data using calculation instructions and are stored,
the patient's respective current measured values are automatically compared with measured values from the stored comparative curve which correspond to the respective time or to the respective training stage in order to generate the proposals for modifying the training program if the patient's measured values differ from the progress curve by a prescribable minimum value,
and wherein the comparative curves for at least two subgroups of comparative patients are calculated and are used for the comparison with the patient's current measured values in order to determine the patient's membership of one of the subgroups.

21. The method as claimed in claim 20, wherein at least some of the patient data are retrieved from a second database which contains an electronic patient record.

22. The method as claimed in claim 20, wherein the measured values for the measured variables relating to implementation and/or for quantification of interim results for the training program completed by the patient are recorded automatically, or are input by the patient, on the second data processing station during implementation of the training program.

23. The method as claimed in claim 20, wherein the patient data are repeatedly recorded and updated during the training program in order to automatically generate proposals for modifying the training program.

24. A method for supporting therapy planning in the rehabilitation of a patient, comprising:
recording patient data for a patient, the patient data including measured values for measured variables relating to implementation and/or for quantification of interim results for a training program completed by the patient;
providing a first database which contains rules for linking patient data to proposals for modifying training programs;
automatically generating, from a first or a second data processing station, one or more proposals for modifying or retaining the training program completed by the patient by reverting to the first database and the patient data; and
outputting the generated proposals on the first or on a further data processing station, wherein, upon identification of an unfavorable link between the patient's training program and the recorded patient data, a warning is automatically produced and is output on the first and/or on a further data processing station together with that portion of the patient data which relates to the unfavorable link.

25. A system for supporting therapy planning in the rehabilitation of a patient, comprising:
a first data processing station and a second data processing station which are at least intermittently able to interchange data with one another via a network,
wherein the first or the second data processing station is connected to a first database which contains rules for linking patient data to proposals for prescribing and/or modifying training programs, the first database further including a first module for automatically generating proposals for prescribing and/or modifying a training program for the patient by reverting to the first database and also for outputting the proposals or for transmitting the proposals to the first or to a further data processing station, wherein the rules contained in the first database take into account reciprocal dependencies for the success of training in different capability categories in order to ensure balanced training success, and
wherein the second processing station includes a second module for recording the measured values for measured variables relating to implementation and/or for quantification of interim results for a training program completed by the patient and for transmitting these measured values or already generated proposals to the first data processing station and/or for storing these measured values in a second database.

26. The system as claimed in claim 25, wherein the second data processing station is connected by way of one or more interfaces to measured-value sensors for recording at least some of the measured values and/or comprises modules for computer-assisted testing of the patient.

27. The system as claimed in claim 25, wherein the rules contained in the first database take into account influences of other illnesses in the patient which are contained in the patient data.
